(19) United States
(12) Patent Application Publication
(10) Pub. No.: US 2006/0060633 A1
(43) Pub. Date: Mar. 23, 2006

(54) High strength insulating metal-to-ceramic joints for solid oxide fuel cells and other high temperature applications and method of making

(75) Inventors: K. Scott Weil, Richland, WA (US); Lawrence A. Chick, West Richland, WA (US); Christopher A. Coyle, Pasco, WA (US); John S. Hardy, Richland, WA (US); Guanguang Xia, Pasco, WA (US); Kerry D. Meinhardt, Kennewick, WA (US); Vincent L. Sprenkle, Richland, WA (US); Dean M. Paxton, Kennewick, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 10/948,346

(22) Filed: Sep. 22, 2004

(51) Int. Cl. H01M 2/02

(52) U.S. Cl. 228/101; 429/34

(57) ABSTRACT

A seal formed between a metal part and a second part that will remain gas tight in high temperature operating environments which experience frequent thermal cycling, which is particularly useful as an insulating joint in solid oxide fuel cells. A first metal part is attached to an reinforcing material. A glass forming material in the positioned in between the first metal part and the second part, and a seal is formed between the first metal part and the second part by heating the glass to a temperature suitable to melt the glass forming materials. The glass encapsulates and bonds at least a portion of the reinforcing material, thereby adding tremendous strength to the overall seal. A ceramic material may be added to the glass forming materials, to assist in forming an insulating barrier between the first metal part and the second part and to regulating the viscosity of the glass during the heating step.

### STATEMENT OF GOVERNMENT SUPPORT

The invention was made with Government support under Contract DE-FC26-02NT41246, awarded by the U.S. Department of Energy. The Government has certain rights in the invention.

### TECHNICAL FIELD

The present invention relates to a system and method for forming high strength, gas-tight, insulating joints between parts used in high temperature applications, and the joints made thereby. While not meant to be limiting, the present invention has particular utility when used in the fabrication and operation of solid oxide fuel cells.

### BACKGROUND OF THE INVENTION

Solid Oxide Fuel Cells (SOFC) are solid state devices that convert chemical energy of the incoming fuel directly to electricity via an electrochemical reaction. Due to their high efficiency and low emissions, SOFCs have become increasingly attractive to a number of industries, such as utility and automotive industries. Among different SOFCs, the planar type is expected to be more mechanically robust, have a high power-density, and provide a more cost-effective design for large scale manufacturing. In the SOFC stacks, the interconnect is used to physically separate the fuel at the anode side and the air or oxidant at the cathode side. It also functions as a bi-polar plate, electrically connecting a number of ceramic cells or PENs (Positive cathode-Electrolyte-Negative anode) in series in the stack. For SOFC stacks to function properly, the interconnect has to be hermetically sealed to the adjacent components, i.e. the PEN or a metallic frame holding the PEN. The seals between adjacent interconnects must be electrically insulating to prevent shorting. The electrically insulating sealing is often carried out using a glass-ceramic, though other sealing technologies are also under consideration. In order to maintain the structural stability and minimize the degradation of SOFC performance, the sealing materials are required to be chemically compatible to the interconnect.

In most planar SOFC stacks that operate at an intermediate temperature (700-800° C.), the interconnect is typically made from a ferritic stainless steel and has to be hermitically sealed to its adjacent components by a sealing glass.

One of the inherent problems that have been found with glass sealing is the formation of an oxide scale at the interface between the glass and the metal structure component. Initially this scale layer is well attached to the underlying metal substrate, but after long-term exposure to the high temperature operating conditions of the SOFC stack, the scale thickens and thereby weakens, eventually becoming a source of failure in the glass-to-metal sealing joints, particularly upon thermal cycling. One way to alleviate this problem is to roughen the surface of the metal substrate such that the glass seal is mechanically locked into place. However, it has been shown that simple sand blasting or grain boundary etching do not provide a sufficiently “roughened” surface to form a seal that will not fail under the typical operating conditions of an SOFC stack.

Another problem is it is difficult to control the viscosity of the glass at the sealing temperature and it can become quite fluid. If the glass is too fluid, it can be squeezed out during the sealing process, particularly if loaded or compressed during the sealing step to make sure the parts mate properly.

Thus, there is a need for improved methods of connecting the metal and ceramic parts used in high temperature applications such as are found in SOFCs.

### SUMMARY OF THE INVENTION

It is therefore an object of the present invention to provide a method by which a seal may be formed between a metal part and a second part that will remain gas tight in high temperature operating environments which experience frequent thermal cycling. It is a further object of the present invention to provide the seal formed by this method as having insulating properties which will prevent electrical conductivity between the first metal part and the second part. These and other objects of the present invention are achieved by first providing a first metal part and a second part. The second part may be ceramic or it may be metallic and treated in the manner described below for the first metal part. A metallic reinforcing material, such as a porous mesh or series of metallic protuberances (including but not limited to metal spheres, particles, wires, screens and fibers), is then attached to the first metal part. Any prior art method for attaching the reinforcing material to the metal part that will form a durable, strong connection between the screen or other reinforcing material and the first metal part is suitable, including without limitation, brazing, welding, sintering, and the like. A glass forming material is then positioned in between the first metal part and the second part, a seal is formed between the first metal part and the second part by heating the glass to a temperature suitable to soften the glass forming material. In this manner, a glass or glass-ceramic layer is formed which is bonded on one side to the first metal part and bonded on the opposing side to the second part. Prior to cooling, the molten glass thus formed will infiltrate through the reinforcing material and thereby encapsulate at least a portion of the attached metal screen or metal protuberances. In this way, when tensile, shear, or torsion forces are applied to the joint, a significant portion of the load is transferred from the glassy matrix to the metal-to-metal bonds between the reinforcing material and the underlying metal substrate. These metal-to-metal bonds will bear substantially higher loads than will the planar glass-oxide scale-metal interfaces present in traditional glass-metal joints. Secondarily, the reinforcing material also acts as a metal reinforcement phase within the glass or glass-ceramic matrix and thereby enhances the fracture toughness of the base glass material via various crack deflection and crack blunting mechanisms. Both effects significantly increase the strength of the composite seal over that of traditional glass-metal seals.

While the motivation for the development of the present invention was to provide robust insulating joints in solid oxide fuel cells, those having skill in the art will recognize that the joint of the present invention, and the method for forming the joint of the present invention, is equally applicable in any circumstance which requires a gas tight, insulating seal between a first metal part and a second part, particularly applications that involve high temperature operating environments for the parts. Therefore, the present invention should be in no way be construed as being limited to applications involving solid oxide fuel cells, and should instead be interpreted as encompassing any and all applications wherein a robust insulating joint is required.

Also, while the motivation for the development of the present invention was more particularly to provide robust insulating joints between two metal parts in solid oxide fuel cells, those having skill in the art will recognize that the joint of the present invention, and the method for forming the joint of the present invention, is equally applicable in circumstances wherein only one of the parts is a metal part. For example, and not meant to be limiting, within many designs for solid oxide fuel cells, interfaces between a metal part and a ceramic part also exist, which may require a gas tight, insulating seal. Therefore, the present invention should be in no way construed as being limited to applications involving seals between two metal parts, whether in a solid oxide fuel cell or otherwise, and should instead be interpreted as encompassing any and all applications wherein a robust insulating joint is required between any two parts wherein at least one of the parts is metal.

Preferably, and not meant to be limiting, the metal parts and the metallic reinforcing material(s) used in the present invention are selected as high temperature stainless steels and high temperature superalloys. Exemplary high temperature stainless steels would include Durafoil (alpha-4), Fecralloy, Alumina-coated stainless steel and Crofer-22APU. Exemplary superalloys would include Haynes 214, Nicrofer 6025, and Ducralloy. The metal parts and reinforcing components need not be the same alloy, but should be compatible with one another under the conditions intended for sealing and eventual service.

Preferably, and not meant to be limiting, the thickness of the joints formed by the present invention is within the range of approximately 0.1 mm to 2 mm.

When forming the joints of the present invention, a ceramic material may be juxtaposed between the first metal part and the second part. The ceramic material may serve more than one function. For example, the ceramic material may assist in forming an insulating barrier between the first metal part and the second part integral to the glass formed from the glass forming material. Further, the ceramic material may assist in regulating the viscosity of the glass during the heating step. Preferably, but not meant to be limiting, the ceramic material modifies the molten glass such that it becomes sufficiently viscous to maintain separation between the metal part and the second part, the reinforcing material attached to the metal part and the second part, or the reinforcing material attached to a first metal part and the reinforcing material attached to a second metal part, thereby preventing the formation of an electrical pathway between the two parts. At the same time, it is preferable that the ceramic material allow the molten glass to maintain sufficient fluidity so as to allow the glass to infiltrate and penetrate the reinforcing material(s) attached to the part(s), thereby encapsulating and adhering directly to the reinforcing material(s) and underlying metal substrate(s). In this manner, the glass is bonded directly to the parts, producing a gas tight seal between the parts and at the same time, infiltrates into the reinforcing material to produce a highly durable bond. Preferably, and not meant to be limiting, the ceramic material is selected as zirconia, stabilized zirconia, alumina, nickel oxide, and combinations thereof. To minimize or control the amount of squeeze out during sealing, this invention contemplates, but not to be limiting, incorporating small monosize ceramic (exemplary yttria stabilized zirconia) spheres at approximately about 2 to 5% volumetric loading into the glass-forming material prior to use in the seal. The ceramic spheres remain geometrically stable and retain their rigid solid form at the sealing temperature, whereas the glass softens and flows. The spheres act simultaneously as load columns and geometric spacers to prevent an excessive amount of glass from squeezing out between the two sealing surfaces during the heating and compression step employed in seal formation. The spheres also eliminate potential metal to metal contact in the cell frame, thereby preventing the stack from electrically shorting. Also preferably, and not meant to be limiting, the ceramic is provided as small fibers, approximately 1 mm in length by 20 μm in diameter, which are homogeneously distributed within the glass forming material prior to the heating and seal formation. An example of a suitable ceramic of this type is Type ZYBF material which may be purchased from Zircar Zirconia, Inc. of Florida, N.Y. Also preferably, and not meant to be limiting, glass-forming material containing no ceramic fiber or particulate is applied locally to each of the reinforcing surfaces on the two metal parts, for example as a paste, and allowed to infiltrate. A second glass-forming material containing ceramic fibers, spheres, or porous matting is placed between the two parts and heated to seal. In this way, both glass infiltration into the reinforcing material and formation of an electrically insulating seal can be readily ensured.

The glass itself may comprises, but is not limited to, about 10 mole % B₂O₃, about 35 mole % SiO₂, about 5 mole % Al₂O₃, about 35 mole % BaO, about 15 mole % CaO and other forms of glass fro the barium aluminosilicate family and combinations thereof. The glass is preferably mixed with organic binder materials, such as those that may be purchased from the Ferro Corporation, of Cleveland, Ohio. Appropriate choice of the binder and accompanying solvent(s) allows either a glass-forming paste to be formulated or thin sheets or tapes of glass-forming material to be prepared. In particular, a paste allows the glass forming materials to be applied to the metal part and the second part in precise locations, and in precise quantities, to allow the formation of the gas tight seal. The metal part and the second part are then placed together-and heated at a sufficient time and at a sufficient temperature to completely oxidize, gasify, and thus remove the organic binder materials, and to allow the glass forming materials to melt and form a glass that infiltrates and at least partially if not completely encapsulates the bonded reinforcing material, thereby forming the gas tight, insulating joint of the present invention. For the preferred materials described herein, heating at 825° C. for 1 hour is sufficient to form the joint.

### BRIEF DESCRIPTION OF THE DRAWINGS

The following detailed description of the embodiments of the invention will be more readily understood when taken in conjunction with the following drawing, wherein:

FIG. 1 is a diagram comparison of a SOFC window frame component to the rupture test specimen (not shown to comparative scale);

FIG. 2 is a diagram of a cassette to cassette seal.

FIG. 3 is a schematic diagram of the rupture test apparatus;

### DETAILED DESCRIPTION OF THE PREFERRED EMBODIMENTS

A series of experiments were conducted to demonstrate the apparatus and method of the present invention, and to test the joints, or seals, formed by the present invention. While these experiments are useful in demonstrating certain features and aspects of the present invention, they should in no way be interpreted as an exhaustive demonstration of all the various aspects of the invention. As will be recognized by those having skill in the art, many of the advantages of the present invention can readily be achieved with significant variations from the experiments described herein, including, without limitation, the selection of the materials, and the methods and operating parameters used to combine those materials. Accordingly, the present invention should be broadly construed to include all such modifications and equivalents thereto that are encompassed by the appended claims.

This invention contemplates using reinforcing material, for example, a metal powder, metal wire, mesh screen or a series of metallic protuberances which are sintered, etched or machined to the metal substrate or any other form of metal that can be firmly anchored to the substrate and subsequently surrounded by the sealing glass. One concept of this invention is that, when tensile or shear or torsion forces are applied to the joint, the load is transferred to the metal-to-metal joins between the reinforcing materials and the substrate. These metal-to-metal joins will bear much higher loads than will the glass-oxide scale-metal interfaces.

To test the durability of the seals formed by the present invention, a series of parts were joined together. In one embodiment, a first part consisting of a metal ring resembling a common washer, having an inside diameter of 15 mm and an outside diameter of 44 mm, was joined to a second part consisting of a flat disk, 25 mm in diameter. Various metals were selected, and then joined together by placing glass forming materials between the parts and then heating them at sufficient temperature for a sufficient time to melt the glass forming materials, thereby forming them into a glass and adhering the glass to the surfaces of the metal parts. In some experiments, only the glass forming materials were used to form the bond, in other experiments, screens of generally the same geometry as their corresponding metal parts were first welded to the parts as described herein, and in yet further experiments, additional ceramics, as also described herein, were also added to the glass forming materials.

In a second embodiment, metal screens of generally the same geometry as the metal ring were first welded to the parts as described herein and second part comprising a ceramic bilayer disk, consisting of nominally an 8 μm thick YSZ layer attached to a 350 μm thick anode material that was glass sealed as described previously to the YSZ side of the disk. In comparison, a SOFC window frame consist of a metal support, glass forming materials, and an anode/electrolyte. A SOFC cassette consists of the previously described window frame bonded (laser welded) to a metallic separator plate. The sealed metal ring to ceramic bilayer disk test specimens approximate sealing in the window frame component, while the sealed metal ring to metal disks specimens approximate the sealing between cassettes, which is used when forming a complete SOFC stack.

The first and second parts were then tested to determine if a conductive path was present from the first part to the second part. Finally, pressure was then applied through the hole in the first part until the seal broke and the second part “popped off,” or ruptured. While these rupture strength tests do not provide an absolute measure of the strength of the various seals, they do provide an excellent measure of the relative strength of the seals when comparing such variables as the various materials used for the parts, the presence or absence of the reinforcing materials, and the presence or absence of the ceramics added to the glass forming materials. Table 1 summarizes examples of various specimens, the metal component, the seal type and the ceramic components used in the testing of this invention.

Table 2 summarizes the rupture strength values as a function of test condition. All of the strength values are reported in pounds per square inch (psi). The sealing specimens were configured using a 20 mil Crofer-22 APU and Ni-YSZ/YSZ bilayers prepared as described herein. The sealing was conducted at 825° C. for 1 hour, then annealed at 750° C. for 4 hours prior to cooling to room temperature. Thermal cycle testing was conducted by heating from air temperature to 750° C. in 10 minutes, holding at 750° C. for 10 minutes, and cooling back to room temperature in 40 minutes. Age testing (soaking) was conducted in static air at 750° C.

The glass identified as “G-18” is formed of about 10 mole % B₂O₃, about 35 mole % SiO₂, about 5 mole % Al₂O₃, about 35 mole % BaO, about 15 mole % CaO, and an organic binder that is gasified during the heating step, described as a preferred embodiment in the foregoing summary of the invention.

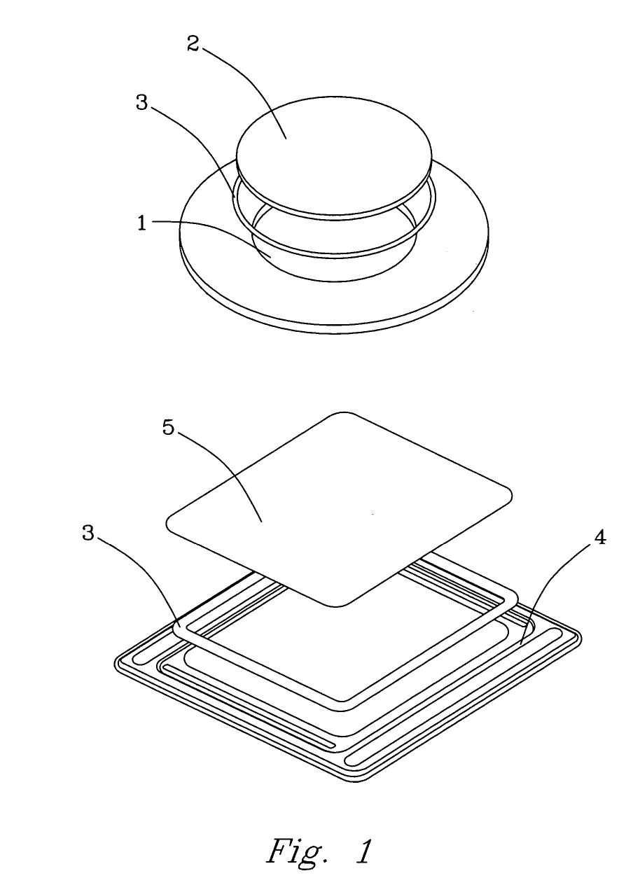

By example, FIG. 1 shows how the testing of the present invention was carried out. The test employs essentially a miniaturized version of the main fuel cell components, i.e. window frame and cassette, as the test specimen. According to FIG. 1, a metal washer 1 acts a the metal frame of a SOFC. A 25 mm diameter ceramic bi-layer coupon 2 or metal disk is sealed with a glass seal 3 directly to a metal washer 1. By comparison, a frame 4 of the same composition used in the pSOFC stack, that measures 44 mm in outside diameter with a 15 mm diameter concentric hole, is sealed with a glass seal 3 to an anode-supported bi-layer coupon 5. Like the actual ceramic pSOFC cell, the anode-supported bi-layer coupons 2 and 5 consist of NiO-5YSZ as the anode and 5YSZ as the electrolyte. The bi-layer coupons were fabricated by tape casting and co-sintering techniques developed at Pacific Northwest National Laboratory. To prepare the anode layer, NiO (J. T. Baker, Inc.), 5YSZ (Zirconia Sales, Inc.), and carbon black (Columbia) powders were ball milled together in a 38:25:37 volume percent ratio for 1½ days with a proprietary binder and dispersant system in a 2-butanone/ethyl alcohol solvent. The slurry was cast onto silicone-coated mylar, forming a ˜0.4 mm thick tape after solvent evaporation. The electrolyte tapes were prepared by ball milling 5YSZ with a proprietary binder and dispersant system in 2-butanone/ethyl alcohol for 2 days and casting the slurry by the doctor blade technique onto silicone-coated mylar to form tapes with an as-dry thickness of approximately 50 μm. The anode and electrolyte tapes were then laser cut into 100×100 mm plies. Multiple plies of the anode tape were laminated together with a single ply of the electrolyte tape through a combination of heat and pressure to form a single green bi-layer tape. Disks measuring 30 mm in diameter were cut from the laminated tape using a circular hot knife. The green parts were then sintered in air at 1350° C. for 1 hr, yielding finished bi-layer components measuring nominally 25 mm in diameter by 600 μm in thickness, with an average electrolyte thickness of ˜8 μm.

The metal materials employed in ring and disk fabrication were procured as 300 μm thick sheet in the as-annealed condition, unless otherwise specified. The flat washer-shaped and disk-shaped specimens were cut from the sheets via electrical discharge machining and the sealing surface was polished to a nominal 10 μm diamond grit finish, flushed with de-ionized water to remove the grit, ultrasonically cleaned in acetone for 10 minutes, and wiped with methanol prior to use. Reinforcing materials, by example metal screens of nominally the same size and geometry as the ring and disk pieces, were cut and spot welded to the corresponding flat metal parts to form the reinforcing surface for the glass matrix in the seal.

The glass seal composition, for example designated as G-18, was an in-house designed barium calcium aluminosilicate based glass originally melted from the following mixture of oxides: 10 mole % B₂O₃, 35 mole % SiO₂, 5 mole % Al₂O₃, 35 mole % BaO, and 15 mole % CaO. The G-18 powder was milled to an average particle size of ˜20 μm and mixed with a proprietary binder system to form a paste that could be dispensed onto the substrate surfaces at a uniform rate of 0.075 g/linear cm using an automated syringe dispenser. In this manner, the glass paste was dispensed onto the YSZ side of the bilayer disks or reinforcing material side of a metal disk. Each disk was then concentrically positioned on a washer specimen, loaded with a 50 g weight, and heated in air under the following sealing schedule: heat from room temperature to 850° C. at 10° C./min, hold at 850° C. for one hour, cool to 750° C. at 5° C./min, hold at 750° C. for four hours, and cool to room temperature at 5° C./min.

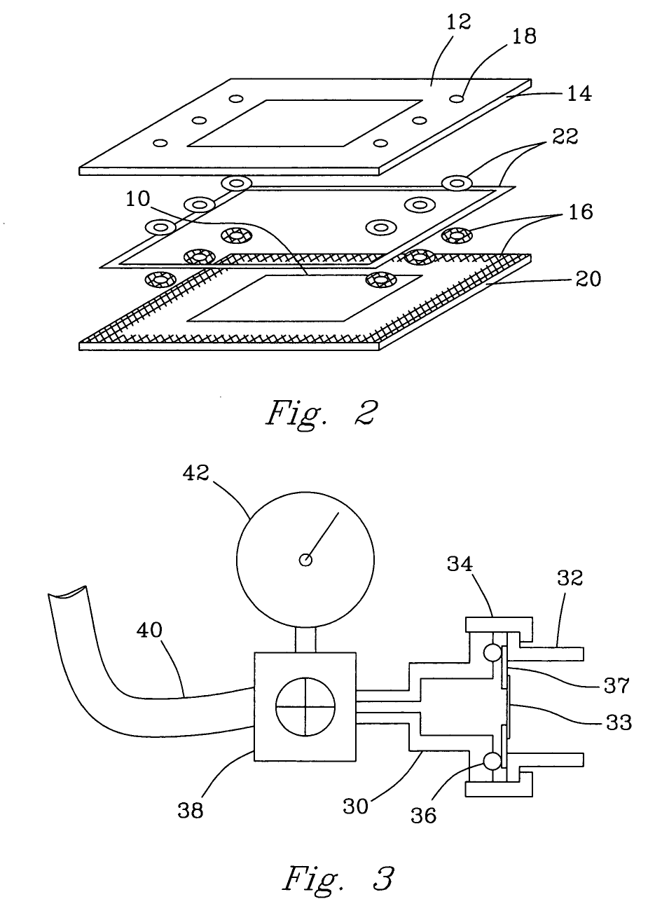

As illustrated in FIG. 2, the SOFC cassette is the repeat unit of the SOFC stack. It consists of the ceramic PEN 10 (bilayer with cathode layer applied) sealed into a metallic frame 12, forming the previously described window frame, which is bonded (laser welded) to a metallic separator plate 14. In the GFM concept, the reinforcing material 16 (e.g. mesh) is pre-joined to the sealing surfaces on each cassette, including the surface around each manifold opening 18 and the outer periphery of the cassette 20. A glass forming material 22, typically containing a ceramic spacer material (fiber, spheres, particulate, etc.) to ensure electrical insulation between cassettes, is used to hermetically seal adjacent cassettes together. The entire stack of cassettes is typically joined in a single sealing operation.

A schematic of the experimental set-up used in rupture testing is illustrated in FIG. 3. The test sample was placed within a fixture that consists of a bottom 30 and top flange 32, a coupling 34 secures and centers the two flanges 30,32, and an o-ring 36 is squeezed against the bottom surface of the washer. Compressed air pumped through air line 40 was used to pressurize the backside of the washer specimen up to a maximum rated pressure of 150 psi. A digital regulator 38 allows the pressure behind the joined bi-layer disk 33 to be slowly increased to a given set point. This volume of compressed gas can be isolated between the specimen and a valve, making it possible to identify a leak in the seal by a decay in pressure. In this way, the device can be used to measure the hermeticity of a given seal configuration without causing destructive failure of the seal. Alternatively, by increasing the pressure to the point of specimen rupture, we can measure maximum pressure using pressure gage 42 that the specimen can withstand. A minimum of six specimens was tested for each joining condition.

TABLE 1
Specimen configurations corresponding to FIG. 1. All metal substrates are 20 mil thick.

| Specimen | Ring Component | Seal Type | Disk Component |
|---|---|---|---|
| 430-G18T-Bi | 430 stainless steel | G-18 glass, applied as a | NiO—YSZ anode supported |
| | | thin cast tape (prepared | bilayer |
| | | using an organic binder) | |
| | | cut into a ring shape | |
| 430-G18T-APU | 430 stainless steel | G-18 tape (as above) | Crofer-22 APU |
| 430-G18DF-Bi | 430 stainless steel | G-18 glass dispensed as | NiO—YSZ anode supported |
| | | a paste (containing 8% | bilayer |
| | | YSZ fiber) | |
| OxAPU-G18T-Bi | Crofer-22 APU oxidized at | G-18 tape (as above) | NiO—YSZ anode supported |
| | 800° C. for 2 hrs prior to | | bilayer |
| | sealing | | |
| APU-G18DGFM-Bi | Crofer-22 APU substrate with | G-18 glass dispensed as | NiO—YSZ anode supported |
| | spot welded Crofer-22 APU | a paste (containing 8% | bilayer |
| | mesh (100 × 100 plain weave, | YSZ fiber) | |
| | 0.006″ wire diameter) | | |
| APU-G18DGFM-APU | Crofer-22 APU substrate with | G-18 glass dispensed as | Crofer-22 APU substrate with |
| | spot welded Crofer-22 APU | a paste (containing 8% | spot welded Crofer-22 APU |
| | mesh (100 × 100 plain weave, | YSZ fiber) | mesh (100 × 100 plain weave, |
| | 0.006″ wire diameter) | | 0.006″ wire diameter) |

TABLE 2

| | | Average | Minimum | Maximum |
|---|---|---|---|---|
| Seal Type | Test Condition | Strength | Strength | Strength |
| 430-G18T-Bi | As-sealed | 23 | 18 | 27 |
| 430-G18T-Bi | Thermally | 21 | 14 | 28 |
| | cycled 3 times | | | |
| 430-G18T-APU | As-sealed | 33 | 28 | 38 |
| 430-G18T-APU | Thermally | 25 | 21 | 27 |
| | cycled 3 times | | | |
| 430-G18DF-Bi | As-sealed | 21 | 15 | 31 |
| 430-G18DF-Bi | Thermally | 17 | 9 | 27 |
| | cycled 5 times | | | |
| OxAPU-G18T-Bi | As-sealed | 29 | 23 | 43 |
| OxAPU-G18T-Bi | Thermally | 18 | 13 | 23 |
| | cycled 5 times | | | |
| APU-G18DGFM-Bi | As-sealed | 121 | 87 | 132** |
| APU-G18DGFM-Bi | Thermally | 129 | 114 | 134** |
| | cycled 5 times | | | |
| APU-G18DGFM-Bi | Thermally | 128 | 114 | 134** |
| | cycled 10 times | | | |
| APU-G18DGFM-Bi | Thermally | 124 | 110 | 134** |
| | aged for | | | |
| | 100 hrs | | | |
| APU-G18DGFM-APU | As-sealed | 133 | 132** | 136** |
| APU-G18DGFM-APU | Thermally | 133 | 131** | 135** |
| | cycled 5 times | | | |
| APU-G18DGFM-APU | Thermally | 134 | 131** | 136** |
| | cycled 10 times | | | |
| APU-G18DGFM-APU | Thermally | 133 | 132** | 136** |
| | aged for | | | |
| | 100 hrs | | | |

It is evident that various modifications, additions or deletions could be incorporated in the system and method of the present invention without departing from the basic teachings thereof. Also, the various elements and steps described herein are exemplary of an embodiment which is presently considered to be a preferred embodiment, and these are to be interpreted to include equivalents thereof.

Therefore, we claim:

1. A method of manufacturing metal-to-ceramic seals comprising the steps of:
a. providing a first metal part and a second part;
b. attaching an reinforcing material to said metal part(s);
c. providing a glass forming material disposed between said first metal part and said second part;
d. heating said first metal part, said second part, said reinforcing material, and said glass forming material such that said glass forming material infiltrates said reinforcing material, encapsulating and bonding to at least a portion of said reinforcing material, and further forms a gas tight seal between said first metal part and said second part.

2. The method of claim 1 wherein said metal parts are selected from the group consisting of high temperature stainless steels and high temperature superalloys.

3. The method in claim 2 wherein said high temperature stainless steels are selected from the group consisting of Durafoil (alpha-4), Fecralloy, Alumina-coated stainless steel and Crofer-22APU.

4. The method in claim 2 wherein said high temperature superalloys are selected from the group consisting of Haynes 214, Nicrofer 6025, and Ducralloy.

5. The method of claim 1 wherein said seal has a thickness within the range of approximately 0.1 mm to 2 mm.

6. The method of claim 1 further comprising the step of adding a ceramic material to said glass forming material juxtaposed between said first metal part and said second part, thereby forming an insulating barrier between said first metal part and said second part.

7. The method of claim 6 wherein said ceramic material is selected from a group consisting of zirconia, stabilized zirconia, alumina and magnesium oxide.

8. The method of claim 1 wherein said glass forming materials comprises about 10 mole % B₂O₃, about 35 mole % SiO₂, about 5 mole % Al₂O₃, about 35 mole % BaO, aboutl 5 mole % CaO, and an organic binder that is gasified during the heating step.

9. A joint between at a first metal part and a second part comprising:
a. a first metal part having an reinforcing material attached thereto,
b. a second part,
c. a glass seal bonded on one side to said first metal part and bonded on the opposing side to said second part wherein the glass encapsulates and bonds to at least a portion of said reinforcing material and forms a gas tight seal between said first metal part and said second part.

10. The joint of claim 9 wherein said metal parts are selected from the group consisting of high temperature stainless steels and high temperature superalloys.

11. The joint of claim 100 wherein said high temperature stainless steels are selected from the group consisting of Durafoil (alpha-4), Fecralloy, Alumina-coated stainless steel and Crofer-22APU.

12. The joint of claim 100 wherein said high temperature superalloys are selected from the group consisting of Haynes 214, Nicrofer 6025, and Ducralloy.

13. The joint of claim 9 wherein said seal has a thickness within the range of approximately 0.1 mm to 2 mm.

14. The joint of claim 9 further comprising a ceramic material juxtaposed between said first metal part and said second metal part, thereby forming an insulating barrier between said first metal part and said second part integral to glass formed from said glass forming material.

15. The joint of claim 14 wherein said ceramic material is selected from a group consisting of zirconia, stabilized zirconia, alumina and magnesium oxide.

16. The joint of claim 9 wherein said glass comprises about 10 mole % B₂O₃, about 35 mole % SiO₂, about 5 mole % Al₂O₃, about 35 mole % BaO, aboutl5 mole % CaO.

17. An insulating joint in a solid oxide fuel cell comprising:
a. a solid oxide fuel cell having at least a first metal part and a second part,
b. said first metal part having an reinforcing material attached thereto,
c. a glass seal bonded on one side to said first metal part and bonded on the opposing side to said second part wherein the glass encapsulates and bonds to at least a portion of said reinforcing material.

18. The joint of claim 17 wherein said metal part is selected from the group consisting of high temperature stainless steels and high temperature superalloys.

19. The joint of claim 18 wherein said high temperature stainless steels are selected from the group consisting of Durafoil (alpha-4), Fecralloy, Alumina-coated stainless steel and Crofer-22APU.

20. The joint of claim 18 wherein said high temperature superalloys are selected from the group consisting of Haynes 214, Nicrofer 6025, and Ducralloy.

21. The joint in claim 17 wherein said seal has a thickness within the range of approximately 0.1 mm to 2 mm.

22. The joint of claim 17 further comprising a ceramic material juxtaposed between said first metal part and said second part, thereby forming an insulating barrier between said first metal part and said second part integral to glass formed from said glass forming material.

23. The joint of claim 22 wherein said ceramic material is selected from a group consisting of zirconia, stabilized zirconia, alumina and magnesium oxide.

24. The joint in claim 17 wherein said glass comprises about 10 mole % B₂O₃, about 35 mole % SiO₂, about 5 mole % Al₂O₃, about 35 mole % BaO, about 15 mole % CaO.

25. A method of manufacturing metal-to-ceramic seals comprising the steps of:
a. providing a first metal part and a second part;
b. attaching an reinforcing material to said metal part;
c. providing YSZ spheres dispersed within the glass-forming material disposed between said first metal part and said second part;
d. heating said first metal part, said second part, said reinforcing material, and said glass forming material such that said glass forming material infiltrates said reinforcing material, encapsulating and bonding to at least a portion of said reinforcing material, and further forms a gas tight seal between said first metal part and said second part.

26. The method of claim 25 wherein said metal parts are selected from the group consisting of high temperature stainless steels and high temperature superalloys.

27. The method in claim 26 wherein said high temperature stainless steels are selected from the group consisting of Durafoil (alpha-4), Fecralloy, Alumina-coated stainless steel and Crofer-22APU.

28. The method in claim 26 wherein said high temperature superalloys are selected from the group consisting of Haynes 214, Nidrofer 6025, and Ducralloy.

29. The method of claim 25 wherein said seal has a thickness within the range of approximately 0.1 mm to 2 mm.

30. The method of claim 25 further comprising the step of adding a ceramic material to said glass forming material juxtaposed between said first metal part and said second part, thereby forming an insulating barrier between said first metal part and said second part integral to glass formed from said glass forming material.

31. The method of claim 30 wherein said ceramic material is selected from a group consisting of zirconia, stabilized zirconia, alumina and magnesium oxide.

32. The method of claim 25 wherein said glass forming materials comprises about 10 mole % B₂O₃, about 35 mole % SiO₂, about 5 mole % Al₂O₃, about 35 mole % BaO, aboutl 5 mole % CaO, and an organic binder that is gasified during the heating step.
